(19) United States
(12) Patent Application Publication
(10) Pub. No.: US 2010/0254766 A1
(43) Pub. Date: Oct. 7, 2010

(54) METHOD OF COLLECTING BIOGAS GENERATED FROM ORGANIC WASTES IN LANDFILL

(75) Inventors: Hung-Suck Park, Ulsan (KR); Jung-Hoon Kim, Ulsan (KR); Jae-Won Lee, Ulsan (KR); Won-Sik Lee, Ulsan (KR); Yong-Seok Park, Ulsan (KR)

Correspondence Address: DOBRUSIN & THENNISCH PC, 29 W LAWRENCE ST, SUITE 210, PONTIAC, MI, 48342, US

(73) Assignee: Q-Bio Tech Corp, Ulsan (KR)

(21) Appl. No.: 12/678,141

(22) PCT Filed: Sep. 12, 2008
(86) PCT No.: PCT/KR2008/005416

§ 371 Date: Mar. 13, 2010

(30) Foreign Application Priority Data
Sep. 13, 2007 (KR) 10-2007-0092905

(51) Int. Cl. C02F 11/04

(52) U.S. Cl. 405/129.2

(57) ABSTRACT

A method of collecting biogas from organic wastes in a landfill includes a branch pipe installation step of installing a waste liquid input branch pipe and a landfill gas extracting branch pipe in the landfill, and installing a leachate extracting branch pipe under the landfill at a certain slopea fitting installation step of connecting an organic waste pretreatment device, the waste liquid input branch pipe, a landfill gas collecting pipe and the landfill gas extracting branch pipe a pretreatment step of mixing organic wastes with leachate generated from the landfill to produce a waste liquida waste liquid input step of dividing the waste liquid input branch pipe into some regions and progressively inputting and pressing the waste liquid mixed in the pretreatment step and a gas extraction step of extracting and collecting a generated landfill gas.

### TECHNICAL FIELD

The present invention relates to a method of recovering biogas from wastes, particularly a method and system in which some pipes are inserted into the existing sanitary landfills of municipal wastes, and liquid wastes with high organic concentration viz., leachate generated from food waste recycling facilities, sludge generated from sewage treatment plants are periodically injected into the pipes, in order to produce and extract landfill gas comprising high methane percentage through biological decomposition by anaerobic microorganisms existing under anaerobic and intermediate-temperature (35° C.) or high-temperature (55° C.) conditions in the landfill site.

### BACKGROUND ART

Generally, the sludge generated from sewage treatment plants is treated by diverse treatment technologies such as incineration, drying/carbonization, landfill, ocean dumping etc. From economic view point, as a cheapest mode of sewage sludge disposal, most of the sludge generated from the sewage treatment plants is generally dumped into the ocean.

Also, a greater amount of leachate generated during the treatment of food wastes in the food waste recycling facilities is mainly disposed by the ocean dumping.

Since reckless ocean dumping of these wastes has a severe environmental impact, the London Agreement related to prohibition of the ocean dumping comes into effect. Accordingly, a long-range plan for the prohibition of ocean dumping of the wastes has been internationally devised.

In Korea, it is required to gradually reduce the quantity of wastes that are dumped into the ocean. Therefore, it needs a proper scheme to treat the wastes and leachate that is being dumped into the ocean until the ocean dumping is completely prohibited.

Since landfill expenses are relatively low, an alternative method of ocean dumping can be taken into consideration. The Ministry of Environment prohibits direct landfilling of organic wastes having high moisture content. Since landfill disposal of organic solids having high moisture content is allowed only by sanitary landfill provided with landfill gas recovery equipment, it can positively find a method of treating leachate generated from the organic solids or food wastes in landfills and collecting biogas there from.

In general, the method of collecting methane gas using biological reaction of the organic solids under anaerobic conditions is a classical technology for excess sludge treatment using anaerobic digester. Recently, this method is applied to food wastes or process sludge having high solids content. Technologies for enhancing the biodegradability of the solids can be in the form of pretreatments such as ultrasonic techniques.

If the organic wastes of high concentration, which are dumped into the ocean, are treated by the anaerobic digestion process, methane gas of 0.35 m³ is generated when biodegradable volatile solid of 1 kg is biologically decomposed. Consequently, enormous amount of energy can be recovered from the organic wastes of high concentration being dumped into the ocean.

However, the existing anaerobic digesters or improved high-efficiency digester and pretreatment equipments require large-scale building sites and high installation expenses, and are not perfect measures since digested sludge is additionally treated.

### DISCLOSURE

### Technical Problem

The main objective of the present invention is to provide a method for collecting biogas generated from organic wastes, with moisture content of 70-90% and high volatile solids concentration, such as organic sludge generated from sewage treatment plants, food wastes, and leachate generated from food waste recycling facilities being dumped into the ocean. The landfill gas generated in the above process will be extracted and used as a renewable energy source.

Therefore, the present invention is related to a method of collecting biogas from organic wastes in a landfill including a pretreatment method, such as pulverization and fluidization, to improve infiltration and dispersion of the organic sludge and leachate of the food wastes into the landfill, a method of utilizing the leachate collected by an exclusion device installed inside the landfill as a dilute solution to perform the pretreatment, a gravity or pressure sludge input method to diffuse the sludge in the landfill, and a method of extracting the landfill gas generated in the landfill site.

Additional aspects and/or advantages of the invention will be set forth in the following part of the description.

### Technical Solution

In order to accomplish this objective, a method is provided for collecting biogas from organic wastes in the landfill. According to this invention, branch pipes are installed to distribute the liquid waste and landfill gas extracting branch pipes are installed in the landfill site. Leachate extraction pipes are installed under the landfill at a certain slope, a fitting was installed connecting the organic waste pretreatment device, the liquid waste input branch pipe, a landfill gas collecting pipe and the landfill gas extracting branch pipe; a pretreatment step of mixing organic wastes with leachate generated from the landfill to produce a liquid waste; a liquid waste input step of distributing the liquid waste input branch pipe into some regions and progressively injecting and pressing the liquid waste mixed in the pretreatment step; and a gas extraction step of converting the organic matter contained in the liquid waste introduced into the liquid waste input step to landfill gas under anaerobic conditions, and extracting and collecting a generated landfill gas.

The method further comprises a pretreatment facility construction to mix the organic matter with the landfill leachate in the organic waste pretreatment device to pulverize, homogenize and liquefy the organic waste.

One practical example of application can be: in the branch pipe installation step, the liquid waste input branch pipes are installed in type of lattice at intervals of 10 m, and the landfill gas extracting branch pipes are installed in all directions around the liquid waste input branch pipe at intervals of 5 m. The organic wastes are pulverized to have a grain size of 2 to 4 mm in the pretreatment step. The organic waste comprises sludge generated from sewage treatment plants, process sludge from various industries, food wastes, and leachate generated from food waste recycling facilities.

One practical example of application can be: the landfill leachate is utilized as a dilution media to easily disperse the organic matters contained in the waste liquid in the landfill.

One practical example of application can be: the injection of the liquid waste is periodically performed to ensure stable residence time in the landfill and thus increase the efficiency of treating organic matters present in the liquid waste and generate methane gas.

During the interval between two liquid waste injection steps, pressure can be intermittently applied to the landfill and the leachate is circulated uniformly, thereby assisting the diffusion of organic matters contained in the liquid waste.

### BENEFICIAL EFFECTS

Additional branch pipes and fittings are installed under the existing sanitary landfill of municipal wastes including landfill gas outlets, leachate collection and treatment devices and a leachate leak protecting liner system, and more than one of the sludge generated from sewage treatment plants, process organic sludge generated from companies, food wastes, and leachate generated from food waste treatment plants can be mixed and introduced periodically, thereby simultaneously treating the organic wastes which have been dumped in the ocean and obtaining the methane gas as bioenergy, by using the anaerobic biodegradation in the landfill site.

### BRIEF DESCRIPTION OF THE SCHEMATIC DIAGRAMS

The features and advantages of the present invention will be more apparent from the following detailed description taken in conjunction with the accompanying drawings, in which:

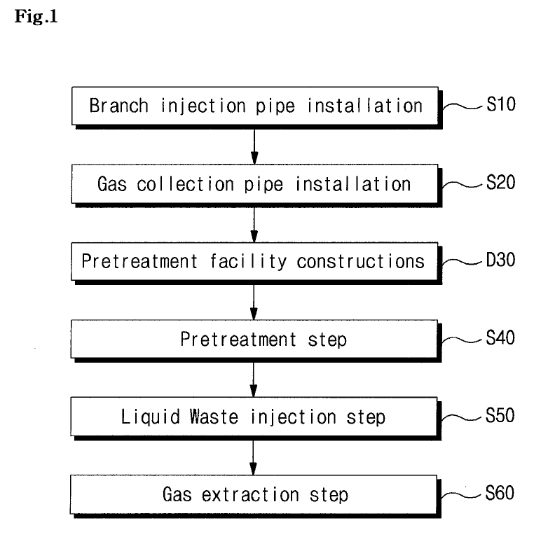

FIG. 1 is an example of the flowchart describing the sequence of the process for collecting biogas from organic wastes in the landfill.

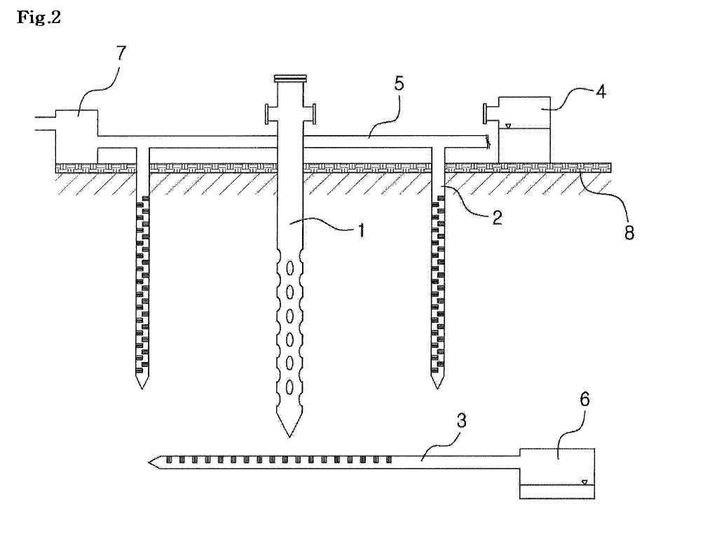

FIG. 2 is an example of a schematic view illustrating the system of treating homogenized liquefied organic wastes through circulation in the landfill and recovering energy there from.

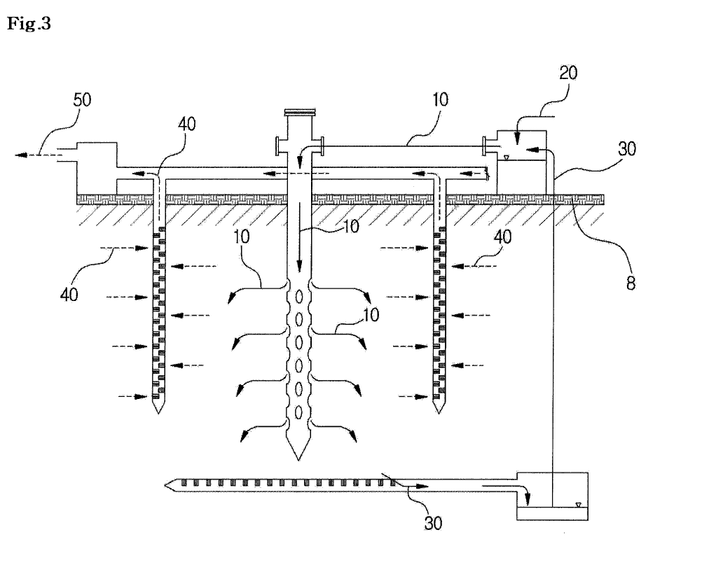

FIG. 3 is an example of a schematic view illustrating the movement of liquid waste, circulation of leachate and extraction of landfill gas.

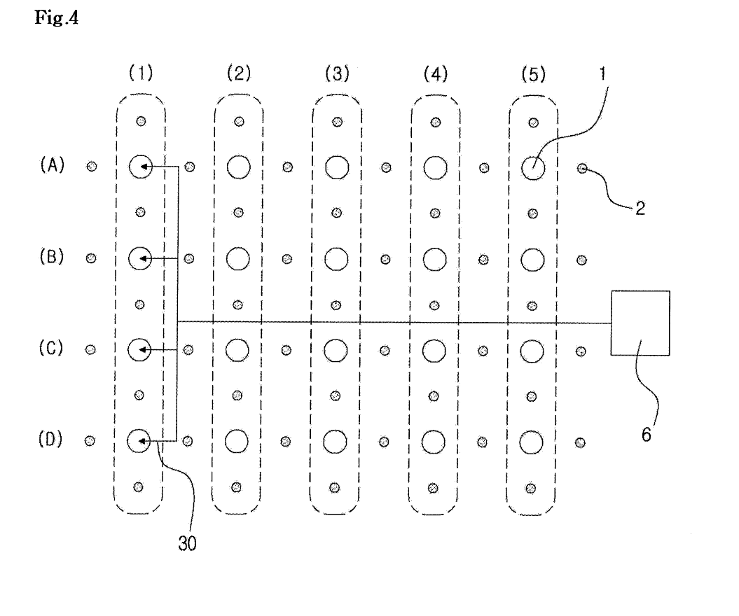

FIG. 4 is an example of a schematic top view illustrating installation of the liquid waste injection branch pipe and landfill gas extraction branch pipe, and injection of the liquid waste at every section.

### BEST MODE FOR THE INVENTION

Before the present method is disclosed and described, one should notice that the terminology used in the specification and any of the claims are not to be interpreted by general meaning commonly known to an ordinary skilled person, but should be understood as meaning and concept suitable for technical idea of the present invention, on the basis of the principle that an inventor is able to define the concept of a certain term for the purpose of describing his invention in the best way.

FIG. 1 is an example of a flowchart describing the sequence of the process for collecting biogas from organic wastes in the landfill. FIG. 2 is an example of a schematic view illustrating the system of treating liquefied stabilized organic wastes through distribution in the landfill site and recovering energy there from. FIG. 3 is an example of a schematic view illustrating movement of liquid waste, distribution of leachate and extraction of landfill gas. FIG. 4 is an example of the schematic top view illustrating installation of the liquid waste injection branch pipe and landfill gas extraction branch pipe, and injection of the liquid waste at every section.

Referring FIGS. 1 to 3, the method of collecting biogas from organic wastes in the landfill site includes a branch pipe installation step (S10) of installing a liquid waste injection branch pipe (1) to introduce organic liquid wastes, a landfill gas extracting branch pipe (2) in the landfill and installing a leachate extracting branch pipe (3) under the landfill at a certain slope; a fitting installation step (S20) for connecting to organic waste pretreatment device (4), the liquid waste injection branch pipe (1), the landfill gas collection pipe (5) and the landfill gas extraction branch pipe (2); a pretreatment step (S40) of mixing organic wastes (20) with the leachate (30) generated from the landfill to produce a liquid waste (10); the liquid waste injection step (S50) for dividing the liquid waste injection branch pipe (1) into some regions and progressively injecting and pressing the liquid waste (10) mixed in the pretreatment step; and a gas extraction step (S60) for converting the organic matter contained in the liquid waste (10) introduced in the liquid waste injection step (S50), and extracting the generated landfill gas (40).

The construction of pretreatment facility (S30) for injecting the organic matter (20) and the landfill leachate (30) into the organic waste pretreatment device (4) may be further provided between the fitting installation step (S20) and the pretreatment step (S40). The term “biogas” means a gaseous fuel, such as methane, that is resulted from eliminating moisture from the landfill gas (40) generated by microorganisms.

In the branch pipe installation step (S10), the liquid waste injection branch pipes (1), the landfill gas extracting branch pipes (2) and the leachate extraction branch pipes (3) are installed in a landfill site, i.e., under a landfill cover (8) of the landfill.

More specifically, the liquid waste injection branch pipes (1) for injecting the pretreated liquid waste (10) containing high-concentration biodegradable organic matter are vertically installed at regular intervals, and the landfill gas extraction branch pipes (2) are vertically installed in all directions around the liquid waste injection branch pipe (1) at regular intervals.

Preferably, the liquid waste injection branch pipes (1) are installed at intervals of 10 m, and the landfill gas extraction branch pipes (2) are installed in all directions around the liquid waste injection branch pipe (1) at intervals of 5 m. The dimensions and installation intervals of the respective branch pipes can be properly selected by a user in accordance with the landfill area and operation conditions.

Preferably, the liquid waste injection branch pipe (1) for injecting the pretreated liquid waste (10) is provided with a number of holes on its circumference in order to easily diffuse the introduced liquid waste (10) uniformly throughout the landfill site, and the landfill gas extraction branch pipe 2 is provided with very small holes.

The leachate extraction branch pipes (3) are installed at a certain slope under the liquid waste injection branch pipe (1) in order to remove leachate introduced when the organic waste is pretreated, leachate generated from the organic wastes, and rain. Preferably, the leachate extraction branch pipe (3) is installed at a slope of 3° or 4°. If the leachate extraction device is previously installed under the landfill to which the present invention is applied, the leachate extraction device can be utilized.

In order to introduce the landfill leachate (30) and discharge the landfill gas (40), a number of holes are preferably formed on the upper portion of the leachate extracting branch pipe (3).

A leachate reservoir (6) for collecting the landfill leachate (30) extracted by the leachate extracting branch pipes (3) is installed throughout the landfill. If the leachate collection and treatment equipments are previously installed in the landfill site, then those equipments can be utilized without further installation.

A part of the collected and treated landfill leachate (30) is transferred to the organic waste pretreatment device (4) installed throughout the liquid waste injection branch pipe (1) by a pump or vehicle for leachate transport.

In the fitting installation step (S20), a moisture separation device (7) is installed within a distance from the landfill gas extraction branch pipe (2) in such a way that the moisture separation device (7) is connected to the landfill gas extraction branch pipe (2). The landfill gas extraction branch pipe (2) is horizontally connected to the moisture separation device (7) by a landfill gas collection pipe (5).

Then, in the input step (S30), the organic matter (20) and the landfill leachate (30) are introduced into the organic waste pretreatment device (4). The organic waste (20) comprises sludge generated from sewage treatment plants, process sludge generated from companies, food wastes, leachate generated from food waste recycling facilities, which are transferred from outside the landfill. Consequently, high-concentration organic wastes that have been usually dumped in the ocean can be recycled, and the energy can be recovered.

The organic wastes (20) introduced into the landfill leachate (30) are utilized as food for microorganisms in the landfill, and are converted into methane gas.

In the pretreatment step (S40), the organic wastes (20) introduced into the organic waste pretreatment device (4) are mixed with the pretreated landfill leachate (30) to dilute and homogenize the high solids concentration continuously, and then the liquid waste (10) is produced by pulverization or addition of alkalinity.

In order to easily disperse the organic matters contained in the liquid waste (10) throughout the landfill site, the landfill leachate (30) is utilized as a diluting medium to provide the organic wastes (20) with desired fluidity.

The rate of methane fermentation comprising acid fermentation step is significantly influenced by the grain size of the organic matter in anaerobic digestion. In case of food wastes discharged from municipal areas, more than 60% have a grain size of 500 mm or more. According to the experimental results, optimum methane yield can be obtained when the food wastes have a grain size of 2 to 4 mm through the pulverizing process. Preferably, the organic wastes (20) are pulverized to have a grain size of 2 to 4 mm in the pretreatment step (S40).

Since the anaerobic digestion process should be performed at near neutral pH to induce high activity of microorganism, alkalinity should be maintained so that pH is not lowered by hydrolysis. Therefore, it is preferable that an alkalizing agent such as NaHCO₃ or Ca(HCO₃)₂ is added.

The generated liquid waste (10) is put into the landfill through the liquid waste injection branch pipe (1) in the liquid waste injection step (S50).

A gravity, negative pressure or pressurizing device (not shown) is provided to the landfill so that the organic matters contained in the liquid waste (10) are evenly dispersed into the landfill. In case air containing oxygen is put into the landfill during the operation of the pressurizing device, the anaerobic digestion process is temporarily or permanently influenced. Therefore, it is advisable to prevent the entry of air containing oxygen into the landfill in the pressurizing process.

In the gas extraction step (S60), the landfill gas (40), containing methane, generated by subjecting the wastes to anaerobic biodegradation is collected and extracted through the landfill gas collection pipe (5) and the landfill gas extraction branch pipe (2), and the collected landfill gas (40) is introduced into the moisture separation device (7) installed near the landfill gas extraction branch pipe (2), so that the methane gas (50) with no moisture is utilized as a fuel, or is further refined to be utilized as raw material or natural gas.

Table 1 shows test results of amount of methane gas per gram of organic wastes.

FIG. 4 is the schematic top view illustrating the installation of liquid waste injection branch pipes (1) and the landfill gas extraction branch pipes (2) over the landfill having an area 3000 m² (50 m×60 m), and injection of the waste at every section. The method of operating the whole system will now be described.

The 20 liquid waste injection branch pipes (1) are installed at intervals of 10 m, and the 49 landfill gas extraction branch pipes (2) are installed around the liquid waste injection branch pipe (1) at intervals of 5 m.

In this instance, the site with the 20 liquid waste injection branch pipes (1) is divided into 5 regions, and then injection of the liquid waste (10) containing the organic matter is done on every 5 days.

More specifically, the injection of the waste is performed at four points of 1A, 1B, 1C and 1D through the liquid waste injection branch pipes (1) on the first day, and then is performed at 2A, 2B, 2C and 2D on the second day. The injection is gradually performed at 5A, 5B, 5C and 5D on the fifth day.

If one cycle is completed, the liquid waste (10) is again introduced at points of 1A, 1B, 1C and 1D once every 5 days, so that a residence time of the organic matter in the landfill is properly maintained in the above process.

This takes operation efficiency into consideration, so as to continuously treat a certain amount of the organic wastes to be discharged every day while properly maintaining the residence time in the reactor that is necessary for methane fermentation of the solids.

In view of the operation efficiency, the organic matter is gradually put into one region in a day, and the previously injected organic matter is evenly dispersed in the remaining regions to ensure the residence time.

It is apparent that a period of 5 days, for example, as the liquid waste injection cycle may be selected depending upon the size of the landfill site and operation conditions thereof.

If the installed intervals of the liquid waste injection branch pipes (1) are identical to each other, the landfill is divided into the more number of regions, and the liquid waste injection cycle is extended, as the landfill area is large. The liquid waste injection cycle is shortened if the landfill area is small.

At the input of the liquid waste (10), a pressure of 0.05 ˜1.0 kgf/cm² is applied inside the landfill from the liquid waste injection branch pipe (1) by using suction, gravity and pressurizing method to easily inject the liquid waste (10).

In order to easily disperse the liquid organic waste (10) while the injection of the liquid waste (10) is not performed, the negative pressure or pressure is applied to the liquid waste (10), or the landfill leachate (30) is circulated from the leachate reservoir (6) to the liquid waste injection branch pipe (1). The pressurizing cycle and the circulating cycle of the landfill leachate (30) are properly selected depending upon site conditions such as the size of the landfill site and operation conditions. Preferably, one to three cycles are performed in a day.

Although preferred embodiments of the present invention have been described for illustrative purposes, those skilled in the art will appreciate that various modifications, additions and substitutions are possible, without deviating from the scope and spirit of the invention as disclosed herein.

1. A method of biogas collection from organic wastes in the landfill, comprising the steps of:
installing a liquid waste injection branch pipe and a landfill gas extracting branch pipe in the landfill to introduce liquid organic waste and installing a leachate extracting branch pipe under the landfill at a certain slope;
a fitting installation step for connecting the organic waste pretreatment device, the liquid waste injection branch pipe, the landfill gas collecting pipe and the landfill gas extracting branch pipe;
a pretreatment facility construction step for mixing organic wastes with leachate generated from the landfill to produce a liquid waste;
a liquid waste injection step for dividing the liquid waste injection branch pipe into some regions and progressively injecting and pressing the liquid waste mixed in the pretreatment step; and
a gas extraction step for converting the organic matter contained in the liquid waste introduced in the liquid waste injection step under anaerobic conditions, and extracting and collecting a generated landfill gas.

2. The method as claimed in claim 1 further comprises the step of providing a pretreatment facility construction for fluidizing and injecting the organic matter and the landfill leachate into the organic waste pretreatment device between the fitting installation step and the pretreatment step.

3. The method as claimed in claim 1, wherein in the branch pipe installation step, the liquid waste injection branch pipes are installed in type of lattice at intervals of 10 m, and the landfill gas extracting branch pipes are installed in all directions around the liquid waste injection branch pipe at intervals of 5 m.

4. The method as claimed in claim 1, further comprising the step of the organic wastes are pulverized to have a grain size of 2 to 4 mm in the pretreatment step.

5. The method as claimed in claim 1, wherein the organic waste comprises more than one of the following such as sludge generated from sewage treatment plants, process sludge generated from various industries, food wastes, leachate generated from food waste recycling facilities.

6. The method as claimed in claim 1, wherein the landfill leachate is utilized as a diluting solution to easily disperse the organic matters contained in the liquid waste in the landfill.

7. The method as claimed in claim 1, wherein the injection of the liquid waste is periodically performed at every region in the liquid waste injection step to ensure stable residence time in the landfill and thus, increase the treatment efficiency of the organic matters contained in the liquid waste and generating methane gas.

8. The method as claimed in claim 7, further comprising the step of intermittently applying pressure to the landfill and the leachate is circulated, thereby assisting diffusion of the organic matters contained in the liquid waste injected into the landfill.
